(19) United States
(12) Patent Application Publication
(10) Pub. No.: US 2014/0166597 A1
(43) Pub. Date: Jun. 19, 2014

(54) FILTER APPARATUS AND WATER FILTRATION SYSTEM AND METHOD

(71) Applicant: Naipaul Khamal, Crossmoor (ZA)

(72) Inventor: Naipaul Khamal, Crossmoor (ZA)

(21) Appl. No.: 14/237,865

(22) PCT Filed: Jul. 27, 2012
(86) PCT No.: PCT/IB2012/053850

§ 371 Date: Feb. 7, 2014

(30) Foreign Application Priority Data
Aug. 10, 2011 (ZA) 2011/06013

(51) Int. Cl. C02F 1/00; B01D 24/10; B01D 29/56

(52) U.S. Cl. CPC C02F 1/001; B01D 29/56; B01D 24/105
USPC 210/806; 210/323.1; 210/335; 210/337; 210/282

(57) ABSTRACT

The present invention relates to a filter apparatus (10), a water filtration system, and a method for operating a water filtration system. The filter apparatus typically comprises a housing (12) defining an inlet port (12.4) connectable to an outlet of a drainage system to receive sullage or grey water therefrom, in use; and an outlet port (12.5) downstream from the inlet port; and a plurality of modular filter devices (20, 22, 24) operatively disposed in the housing (12) to filter the received sullage, in use. The system conveniently comprises a plurality of apparatuses in accordance with the invention provided with inlet ports in flow communication with outlets of drainage systems (17) to receive sullage or grey water therefrom, in use; and outlet ports operatively connected to storm water drainage systems.

### BACKGROUND OF THE INVENTION

THIS INVENTION relates to a filter apparatus, a water filtration system, and a method for operating a water filtration system.

Potable water is in short supply around the world and this problem is exacerbated by excessive consumption for potable water for non-drinking purposes, for example, washing of dishes, laundry, and bathing. Resultant water from these activities, typically referred to as sullage or grey water, comprises a large percentage of residential wastewater.

Although grey water tends not to be heavily polluted, it is, in most cases, not potable and is typically directed into sewage systems of buildings and is recycled along with sewage water (from, toilets, etc.) at a relatively high cost.

It is therefore an object of the present invention at least to address the abovementioned scenario and problems associated with sullage or grey water.

### SUMMARY OF THE INVENTION

According to a first aspect of the invention there is provided a filter apparatus comprising:
a housing defining an inlet port connectable to at least one outlet means of a drainage system to receive sullage or grey water therefrom, in use; and an outlet port downstream from the inlet port; and
a plurality of removable modular filter devices operatively disposed in the housing to filter the received sullage, in use.

It will be noted that one or more of the modular filter devices may advantageously be removably receivable in the housing, in one or both of a nested fashion and a stacked fashion.

The filter apparatus may comprise a removable first filter device comprising a coarse mesh filter for trapping large particles of solid waste from the received sullage, in use. The coarse mesh filter may be disposed at an angle to the inlet port such that a distal zone of the coarse mesh filter is provided opposite, and at a lower elevation than, the inlet port within the housing.

The coarse mesh filter may comprise a ramp removably receivable in a first filter device housing associated with the first filter device. A base of the first filter device housing may further comprise another coarse mesh filter.

In one example embodiment, the filter apparatus may comprise:
a removable second filter device, disposed downstream from the first filter device, the second filter device comprising a fine mesh filter for trapping smaller particles of solid waste received from the first filter device, in use; and
a removable third filter device, disposed downstream from the second filter device, the third filter device comprising a first removable fabric filter comprising cotton fabric, cotton wool, silk fabric, or the like for filtering fluid received from the second filter device, in use.

A second removable fabric filter comprising cotton fabric, cotton wool, silk fabric, or the like may be provided with or disposed in the second filter device.

The third filter device may comprise a plurality of apertures disposed downstream of the first fabric filter.

The filter apparatus may comprise a granular filter provided with or in one or more filter devices. The granular filter may comprise removable charcoal pieces, stones, or the like.

The filter apparatus may comprise a filter device frame receivable in the housing, the filter device frame may comprise a sump having one or more outlets in flow communication with the outlet port of the filter apparatus, wherein the filter device frame may be configured to receive the filter devices removably in one or both a stacked fashion and a nested fashion.

The second and third filter devices may comprise filter trays receivable in the filter device frame together with the first filter device, the filter device frame with the filter devices may be receivable snugly in the housing, in use.

The filter trays may be rectangular filter trays.

The housing may comprise a hollow sealed housing comprising a removable lid; and an overflow outlet port provided substantially adjacent the first filter device.

The apparatus may comprise means defining flow paths attachable to one or more of the inlet port, outlet port and overflow port.

The housing may comprise a parallelepiped shaped body.

The housing may comprise attachment means for facilitating attachment of the filter apparatus to a wall.

According to a second aspect of the invention there is provided a water filtration system comprising a plurality of apparatuses as described above, wherein the apparatuses are provided with:
inlet ports in flow communication with outlets of drainage systems to receive sullage or grey water therefrom, in use; and
outlet ports operatively connected to a storm water drainage system.

The apparatuses may be provided with overflow ports operatively connected to a sewage system.

According to a third aspect of the invention, there is provided a method of operating a water filtration system comprising:
providing a plurality of filter apparatuses as hereinbefore described in flow communication with outlet means of drainage systems to receive sullage or grey water therefrom, in use; and
directing filtered water from the apparatuses to a storm water drainage system.

The method may further comprise filtering the water in the storm water drainage system.

### BRIEF DESCRIPTION OF THE DRAWINGS

FIG. 1 shows a perspective exploded view of a filter apparatus in accordance with an example embodiment;

FIG. 2 shows a perspective partly assembled view of filter apparatus of FIG. 1 in accordance with an example embodiment;

FIG. 3 shows a side view of the partly assembled example embodiment illustrated in FIG. 2 of the drawings;

FIG. 4 shows a perspective view of an assembled filter apparatus in accordance with an example embodiment; and

FIG. 5 shows part of a system in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

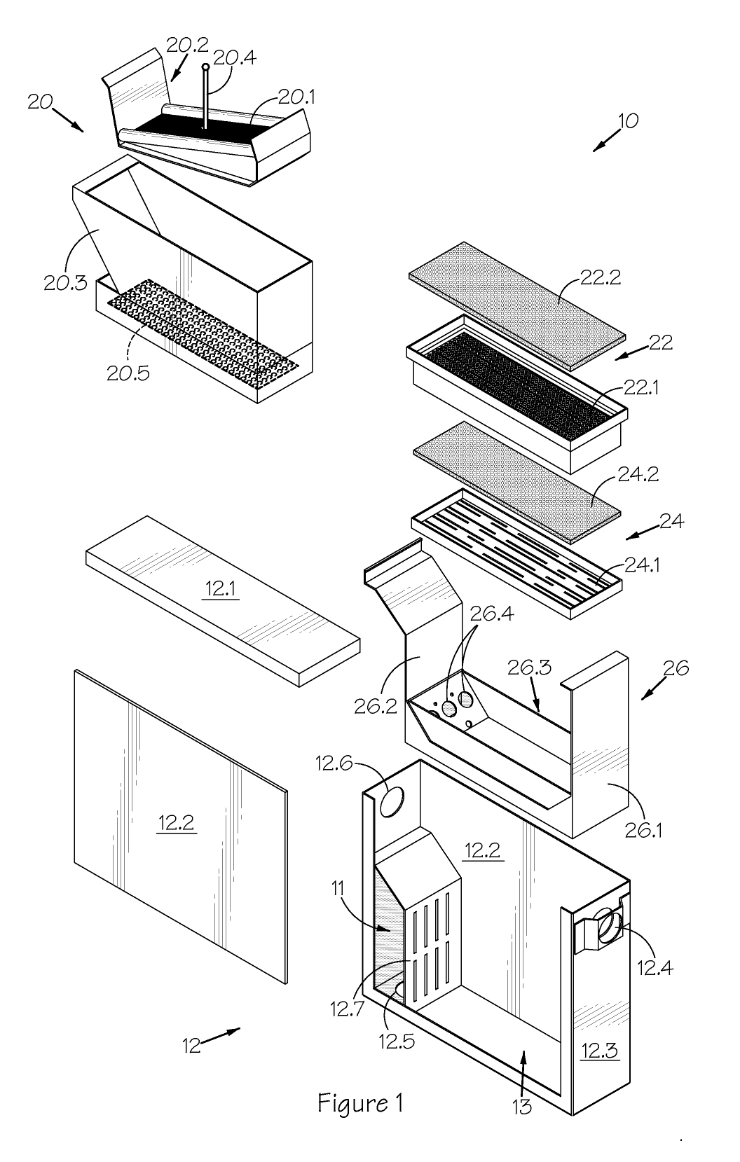

Referring to FIGS. 1 to 5 of the drawings, a filter apparatus in accordance with an example embodiment is generally indicated by reference numeral 10. The filter apparatus 10 is typically used for filtering sullage or grey water received from drainage systems associated with buildings, for examples, buildings associated with households, apartment blocks, hotels, housing settlements, businesses, factories, or the like. To this end, it will be appreciated that though an example embodiment is described with specific reference to a domestic house/household, the apparatus 10 may be scalable in terms of shape and/or dimensions for use with larger or smaller drainage systems, for example, drainage system networks.

In any event, referring to FIGS. 1 to 3, in particular, the filter apparatus 10 comprises a hollow parallelepiped housing, generally indicated by reference numeral 12, constructed of a non-corrosive and/or durable plastic material. The housing 12 may be mountable to a wall, for example, adjacent at least one drain or sink of a drainage system in a household via attachment means such as mirror mounting clips, mounting brackets, or the like (not shown). It will be noted that the housing 12 need not be mounted indoors adjacent a drain or sink, but may be mounted outdoors, provided that the apparatus 10 is in flow communication with at least one outlet means of one or more drain/s or sink/s to receive sullage to be filtered therefrom as will be described below.

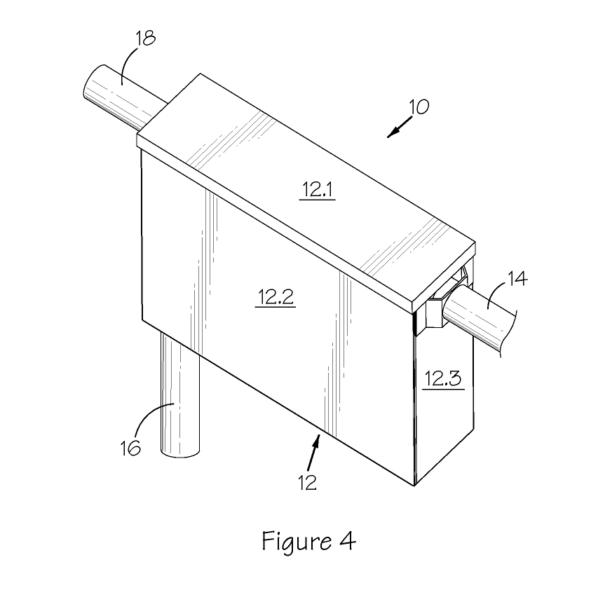

The housing 12 comprises a removable lid 12.1 and optionally removable major panels 12.2 connected to a base panel by interconnecting side panels 12.3 which connected together define a sealed cavity for receiving sullage as illustrated in FIG. 4. The lid 12.1, and panels 12.2, 12.3 may clip together with a sealed frictional fit. Instead, or in addition, the lid 12.1, and panels 12.2, 12.3 may be attached by way of screws, etc.

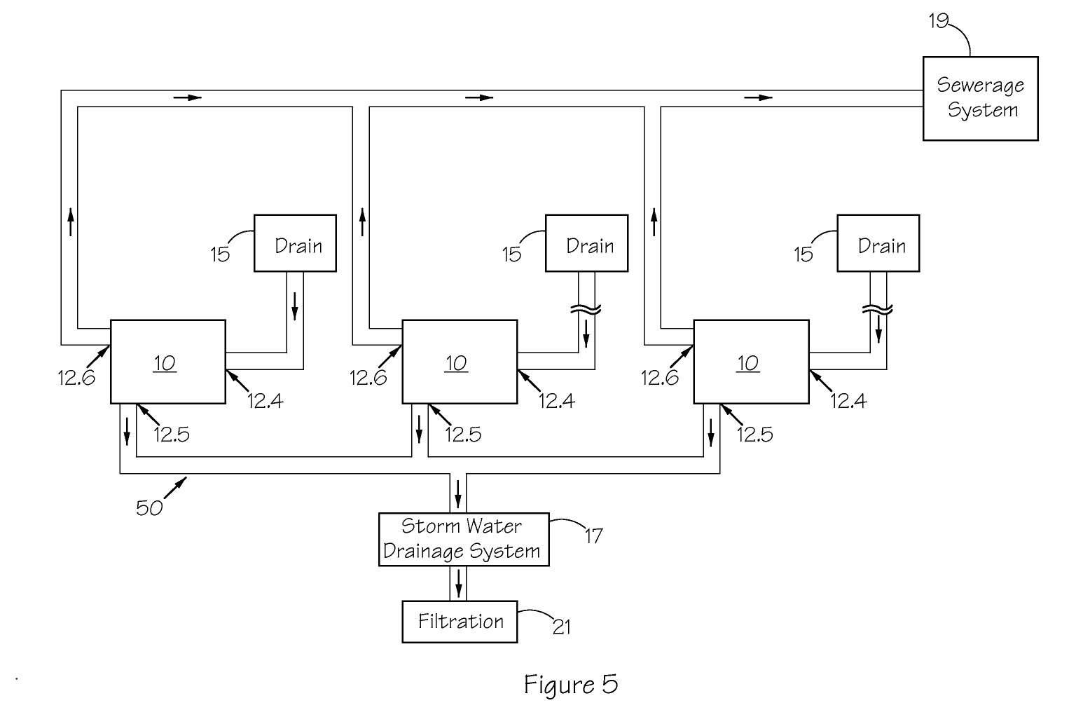

The sealed housing 12 may define a plurality of ports for inlet and outlet of fluid. In one example embodiment, the housing 12 comprises an inlet port 12.4 connectable, via a means defining a flow path, such as a pipe 14 (FIGS. 4 & 5) to at least one outlet means of one or more drain/s or sink/s 15 (FIG. 5) associated with the drainage system of the household to receive sullage to be filtered therefrom.

The housing 12 also comprises an outlet port 12.5 downstream from the inlet port 12.4 and in flow communication with the same. The outlet port 12.5 is advantageously connectable via a pipe 16 to a storm water drainage system 17 (FIG. 5). The housing 12 further comprises an overflow port 12.6 connectable via a pipe 18 to the sewage system 19 (FIG. 5) associated with a household.

It will be appreciated that the storm water drainage system 17 and the sewage system 19 may be conventional systems associated with municipalities and may comprise a network of pipes connecting households to associated filtration systems, e.g., system 21 illustrated in FIG. 5.

It will be appreciated that the port 12.6 is advantageously connected to the storm water drainage system 17 as opposed to the sewage system, as in certain cases, water in the storm water drainage system 17 is conveniently recycled (e.g., by way of filtration system 21) at a lower cost and in a less onerous/tedious manner than water in sewage systems 19.

In other example embodiments, not illustrated, it will be appreciated that the housing 12 may comprise more than one port 12.4, 12.5 and 12.6 as the case may be. However, for ease of illustration, only one of each are shown with the inlet and overflow ports 12.4 and 12.6 being provided on opposite side panels 12.3, substantially on a similar axial plane, and the port 12.5 being provided adjacent the base panel.

The housing 12 also comprises an internal septum or wall 12.7 for separating the housing into an outlet zone 11 and a filtering zone 13. In particular, the septum 12.7 extends parallel to one side wall 12.3, adjacent the outlet port 12.5, to connect to the side wall 12.3 at a region substantially adjacent the overflow port 12.6 thereby to substantially isolate the outlet port 12.5 from incoming sullage. To this end, in some example embodiments, the septum 12.7 is permanently attached to the panels 12.2.

The septum 12.7 may comprise at least one permeable zone comprising one or more apertures for allowing filtered water to pass through to the outlet port 12.5 as will be described below.

The housing 12, particularly the filtering zone 13 thereof, conveniently houses, in a stacked and/or nested fashion a plurality of removable modular filter devices to filter the received sullage as more clearly illustrated in FIG. 1. In particular, the filter apparatus 10 comprises a removable first filter device 20 comprising a coarse mesh filter 20.1 for trapping large particles of solid waste from the received sullage.

The coarse mesh filter 20.1 may be disposed at an angle to the inlet port 12.4 such that a distal zone 20.2 of the coarse mesh filter 20.1 is provided opposite, and at a lower elevation than, the inlet port 12.4 within the housing 12. In this way, waste is directed at least under gravity and/or flow of sullage from the inlet port 12.4 toward the distal zone 20.2 of the filter 20.1.

The coarse mesh filter 20.1 may comprise a ramp removably receivable in a first filter device housing 20.3 associated with the first filter device 20. The coarse mesh filter 20.1 may be constructed of a non-corrosive material such as a metal alloy, or plastic material. Apertures associated with the coarse mesh filter 20.1 may be shaped and dimensioned to trap relatively large particles of solid waste, for example, remnants of bone, fruit, vegetable peels, etc. Smaller particles of solid waste may pass through the filter 20.1. In this way, the first filter device 20 is less prone to clogging by way of received waste. In one example embodiment, the coarse filter may comprise 5 mm holes, spaced 2 mm apart.

The coarse mesh filter 20.1 comprises a spindle-like handle 20.4 for facilitating ease of removal of the filter 20.1 from the housing 20.3, for example, for cleaning purposes if the filter 20.1 is clogged with debris. In some example embodiments, the filter device 20 may comprise a removable basket having handles for ease of removal from the housing 12.

The housing 20.3, may comprise a further coarse filter 20.5 adjacent and below (in assembly) the filter 20.1 thereby to further filter incoming sullage and to allow fluid filtered by the first filter device 20 to fall under gravity to a second removable filter device 22 disposed below the first filter device 20, in assembly.

The second filter device 22 comprises a fine mesh filter 22.1 for trapping smaller particles of solid waste received from the first filter device 20. The fine mesh filter 22.1 may comprise smaller apertures that the coarse filter 20.1 thereby trapping all remaining solid waste and allowing waste water to gravitate to the level below. This filter 22.1 typically traps rice and smaller remnants of bone, fruit, vegetables, etc. In one example embodiment, the coarse filter may comprise 3 mm holes, spaced 1 mm apart.

The second filter device 22 may comprise a rectangular tray comprising the filter 22.1. A fabric filter 22.2 comprising cotton fabric, cotton wool, silk fabric, or the like may optionally be receivable in the tray 22.1 for filtering oils, fats, etc. The fabric filter 22.2 may be reusable and may be provided upstream (above) or downstream (below) the fine mesh filter 22.1. Instead, or in addition, the filter 22.2 may be disposable and replaceable by a like filter 22.2 and may be shaped and/or dimensioned to be received snugly in the tray 22.1.

Downstream from the second filter device 22, particularly below the second filter device 22 (in assembly) is provided a removable third filter device 24. The third filter device 24 comprises a rectangular tray 24.1 comprising defining a permeable bed, comprising a plurality of slit-like apertures, for receiving a removable fabric filter 24.2 comprising cotton fabric, cotton wool, silk fabric, or the like, for filtering fluid received from the second filter device 22. In some example embodiments, the filter 24.1 is substantially similar to the filter 22.2.

The filters 22.2 and 24.2 are advantageously permeable to water thereby to filter the same.

The filter apparatus 10 may comprise a granular filter provided with or in one or more filter devices 20, 22 and 24, for example, in a housing associated with the second filter device 22, downstream from the fine mesh filter 22.1. The granular filter may comprise removable charcoal pieces, stones, or the like to trap oils and emulsions in the sullage. In certain example embodiments, not illustrated, the granular filter may be a separate filter device.

It will be noted that the filter apparatus 10 may comprise a filter device frame 26 receivable snugly in the housing 12 such that a frame wall 26.1 abuts or is very close to the side wall 12.3 and frame wall 26.2 abuts or is very close to the septum 12.7. The frame wall 26.2 may be shaped to follow the septum 12.7 substantially.

The filter device frame 26 may comprise a sump 26.3 having one or more outlet means 26.4 in flow communication with the outlet port 12.5 of the housing 12. To this end, it will be appreciated, the that outlet means 26.4 may be in flow communication with the permeable zone of the septum 12.7 such that filtered water is able to pass through the septum 12.7 and into the outlet zone 11 to exit via the outlet port 12.5. The outlet means 26.4 typically comprises one or more apertures adjacent the permeable zone of the septum 12.7. In this way, only filtered water is advantageously capable of reaching the outlet port 12.5, which is typically isolated from the inlet port 12.4.

It will be appreciated that the outlet means 26.4 may in some example embodiments be connected directly to the outlet port 12.5, for example, via a pipe, etc.

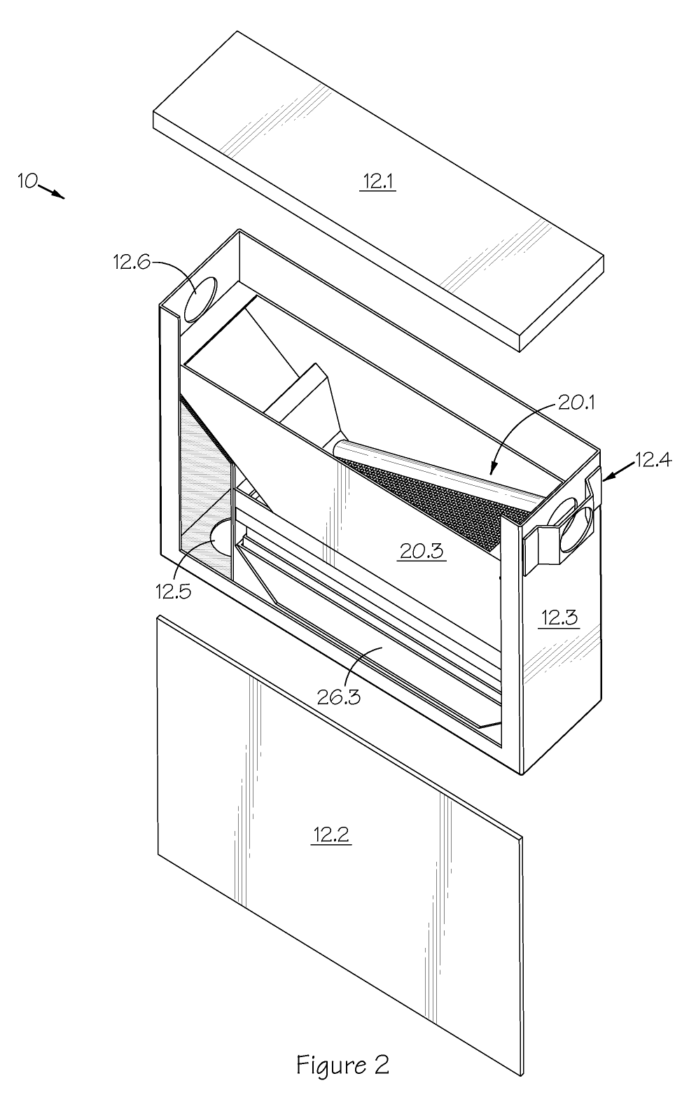

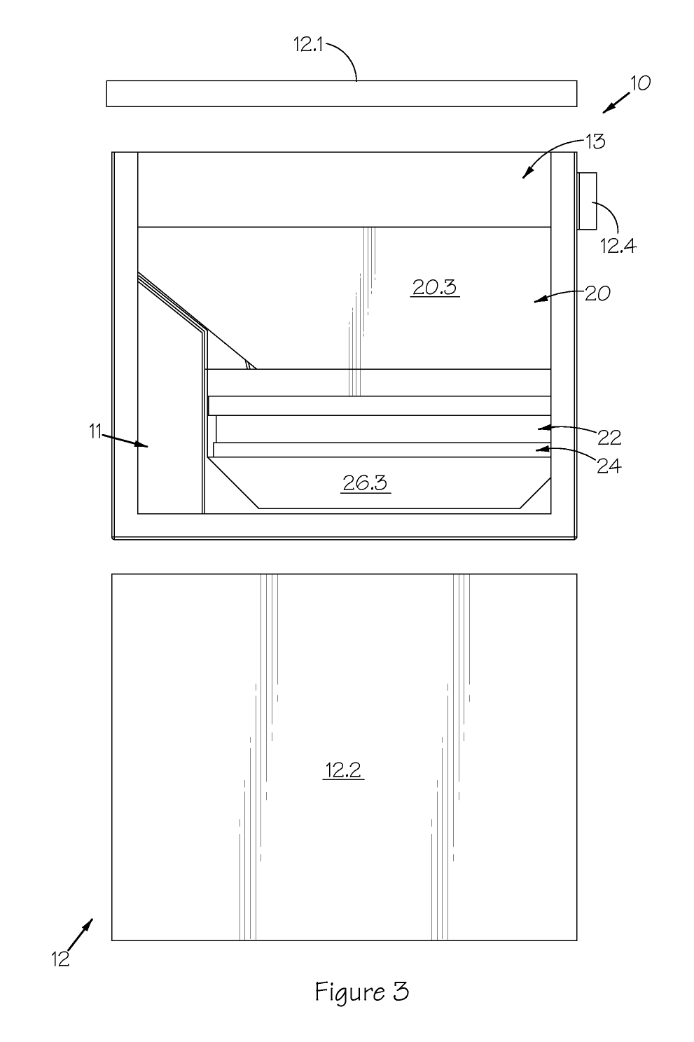

The filter device frame 26 may be configured to receive the filter devices 20, 22, and 24 removably in a stacked fashion and a nested fashion as illustrated more clearly in FIGS. 2 and 3. To this end it will be noted that, in assembly, the tray-like filter device 24 is snugly receivable on top of the sump 26.3; the tray-like filter device 22 is snugly receivable atop the device 24; and the housing 20.3 with the filter 20.1 is receivable atop the device 22, in a stacked and nested fashion.

The frame 26, with the filter devices 20, 22, and 24, are snugly receivable within the filter zone 13 of the housing 12. The lid 12.1 is then attachable to the housing 12 thereby to seal the same with a watertight seal, as illustrated in FIG. 4, save of course for the ports 12.4, 12.5, and 12.6.

It will be noted that the devices 22 and 24, as well as the frame 26 may comprise handles for facilitating ease of handling thereof.

In use, referring to FIGS. 1 to 5, the filter apparatus 10 is mounted to a wall at a desired location, inside or outside, a building associated with a household (referred to as household herein for ease of explanation). In no particular order, referring particularly to FIG. 5, pipe 14 is connected to the inlet port 12.4 and to an outlet means associated with a drain or sink 15 in the household. Pipe 18 is connected to the overflow port 12.6 and to the sewage system 19, and pipe 16 is connected to the outlet port 12.5 and the storm water drainage system 17 associated with the household.

When users wash dishes, etc. in a sink, sullage or grey water from such an activity is passed through a drain associated with the sink and into the inlet port 12.4 via the pipe 14.

The incoming sullage is then filtered via the filter devices 20, 22, and 24 to remove solid debris, oil, grease, etc. thereby to result in substantially cleaner filtered water being collected in the sump 26.3. The angled filter 20.1 advantageously directs larger solid particles of waste to the zone 20.2 under gravity thereby ameliorating clogging of the first filter device 20 by larger particles or pieces of waste.

The other filter stages further advantageously mechanically filter the sullage in a gravity driven manner without the need for complex components or electricity.

It will be appreciated that filtered water in the sump 26.3 may exit through the apertures 26.4 and pass through apertures in the permeable zone of the septum 12.7 and exit the apparatus 10 via the outlet port 12.5 to a storm water drainage system for further processing.

When the apparatus is to be cleaned, the lid 12.1 is advantageously removed from the housing 12 thereby to allow users to access the filters therein. In particular the first filter device 20 may be removed and the frame 26 may be then be removed thereby to remove both the filter devices 22 and 24 substantially simultaneously. The filter devices 20, 22, and 24 may be washed to dislodge waste particles therefrom. The filters 22.2 and 24.2 may be washed or replaced by new substantially similar filters. The apparatus 10 is then reassembled and sealed by way of the lid 12.1 for use in a manner as hereinbefore described.

Referring now to FIG. 5 of the drawings in more detail, it will be appreciated that a plurality of filter apparatuses 10 (only a few are shown for ease of illustration) disposed in households may form part of a system for water filtration, generally indicated by reference numeral 50. Output means of drains 15 are conveniently operatively connected to inlet ports 12.4 of the apparatuses 10. Filtered water from the apparatuses 10 advantageously exits outlet ports 12.5 of the apparatuses 10 and flow into the storm water drainage system 17.

Water in the storm water drainage system 17 may be filtered by a filtration system 21 in a simpler, cost effective manner than filtration of effluent associated with sewage systems 19. The use of the apparatuses 10 advantageously allow or permits grey water or sullage from drains 15 to flow into the storm water drainage system 17 instead of certain conventional arrangements whereby sullage is directed into sewage systems 19 thereby making the same more difficult to recycle at it mixes with effluent in the sewage system.

Left untreated/unfiltered sullage is in most cases not suitable for introduction into the storm water drainage system 17, however, the present invention addresses this problem by conveniently providing an apparatus to filter the same allowing the filtered sullage to be introduced into the storm water drainage system 17.

The apparatus as hereinbefore described is conveniently gravity driven thereby facilitating ease of use as no complicated electrical components are required to be installed. The simple nature of the apparatus advantageously allows the apparatus to be installed by laymen as opposed to skilled plumbers. In addition, the removable modularity of the apparatus permits the apparatus to be easily cleaned and assembled.

1. A filter apparatus comprising:
a housing defining an inlet port connectable to at least one outlet means of a drainage system to receive sullage or grey water therefrom, in use; and an outlet port downstream from the inlet port; and
a plurality of removable modular filter devices operatively disposed in the housing to filter the received sullage, in use.

2. A filter apparatus as claimed in claim 1, wherein one or more of the modular filter devices are removably receivable in the housing, in one or both of a nested fashion and a stacked fashion.

3. A filter apparatus as claimed in claim 1, wherein the filter apparatus comprises a removable first filter device comprising at least one coarse mesh filter for trapping large particles of solid waste from the received sullage, in use.

4. A filter apparatus as claimed in claim 3, wherein the coarse mesh filter is disposed at an angle to the inlet port such that a distal zone of the coarse mesh filter is provided opposite, and at a lower elevation than, the inlet port within the housing.

5. A filter apparatus as claimed in claim 3, wherein the coarse mesh filter comprises a ramp removably receivable in a first filter device housing associated with the first filter device, and also wherein a base of the first filter device housing comprises another coarse mesh filter.

6. A filter apparatus as claimed in claim 3, the filter apparatus comprising:
a removable second filter device, disposed downstream from the first filter device, the second filter device comprising a fine mesh filter for trapping smaller particles of solid waste received from the first filter device, in use; and
a removable third filter device, disposed downstream from the second filter device, the third filter device comprising a first removable fabric filter comprising cotton fabric, cotton wool, silk fabric, or the like for filtering fluid received from the second filter device, in use.

7. A filter apparatus as claimed in claim 6, wherein a second removable fabric filter comprising cotton fabric, cotton wool, silk fabric, or the like is provided with or disposed in the second filter device.

8. A filter apparatus as claimed in claim 7 wherein the third filter device comprises a plurality of apertures disposed downstream of the first fabric filter.

9. A filter apparatus as claimed in claim 6, the filter apparatus comprising a granular filter provided with or in one or more filter devices.

10. A filter apparatus as claimed in claim 9, wherein the granular filter comprises removable charcoal pieces, stones, or the like.

11. A filter apparatus as claimed in claim 6, the filter apparatus comprising a filter device frame receivable in the housing, the filter device frame comprising a sump having one or more outlets in flow communication with the outlet port of the filter apparatus, wherein the filter device frame is configured to receive the filter devices removably in one or both a stacked fashion and a nested fashion.

12. A filter apparatus as claimed in claim 11, wherein the second and third filter devices comprise filter trays receivable in the filter device frame together with the first filter device, the filter device frame with the filter devices being receivable snugly in the housing, in use.

13. A filter apparatus as claimed in claim 12, wherein the filter trays are rectangular filter trays.

14. A filter apparatus as claimed in claim 3, wherein the housing comprises a hollow sealed housing comprising a removable lid; and an overflow outlet port provided substantially adjacent the first filter device.

15. A filter apparatus as claimed in claim 14, wherein the apparatus comprises means defining flow paths attachable to one or more of the inlet port, outlet port and overflow port.

16. A filter apparatus as claimed in claim 1, wherein the housing comprises a parallelepiped shaped body.

17. A filter apparatus as claimed in claim 1, wherein the housing comprises attachment means for facilitating attachment of the filter apparatus to a wall.

18. A water filtration system comprising a plurality of apparatuses as claimed in claim 1, wherein the apparatuses are provided with:
inlet ports in flow communication with outlets of drainage systems to receive sullage or grey water therefrom, in use; and
outlet ports operatively connected to a storm water drainage system.

19. A water filter system as claimed in claim 18, wherein the apparatuses are provided with overflow ports operatively connected to a sewage system.

20. A method of operating a water filtration system comprising steps of:
providing a plurality of filter apparatuses as claimed in claim 1 in flow communication with outlets of drainage systems to receive sullage or grey water therefrom; and
directing filtered water from the apparatuses to a storm water drainage system.

21. A method as claimed in claim 20, further comprising filtering the water storm water drainage system.
